(19) United States
(12) Patent Application Publication
(10) Pub. No.: US 2024/0278182 A1
(43) Pub. Date: Aug. 22, 2024

(54) A COMPOSITION, A METHOD OF MAKING A COMPOSITION, AND A FILTRATION MEMBRANE

(71) Applicant: NEMATIQ IP PTY LTD, Notting Hill, Victoria (AU)

(72) Inventors: Shannon Paul PAPWORTH, Notting Hill, Victoria (AU); Adam James FISCHMANN, Notting Hill, Victoria (AU); Abozar AKBARIVAKILABADI, Notting Hill, Victoria (AU); Samuel Terence MARTIN, Notting Hill, Victoria (AU)

(21) Appl. No.: 18/570,987

(22) PCT Filed: Jun. 15, 2022
(86) PCT No.: PCT/AU2022/050589

§ 371 Date: Dec. 15, 2023

(30) Foreign Application Priority Data
Jun. 15, 2021 (AU) 2021901785

(51) Int. Cl. B01D 67/00; B01D 69/02; B01D 69/10; B01D 71/02; B01D 71/60; C01B 32/198

(52) U.S. Cl. CPC B01D 67/00933; B01D 69/02; B01D 69/10; B01D 71/0211; B01D 71/601; C01B 32/198; B01D 2323/30; B01D 2325/20

(57) ABSTRACT

The present invention relates to a filter and a method of making a filter. The filter includes a porous substrate and a graphene oxide membrane and can be used to filter fluids.

### RELATED APPLICATION

This application claims priority to Australian provisional application number 2021901785 filed on 15 Jun. 2021. The contents of the provisional application are hereby incorporated into the present specification.

### FIELD OF THE PRESENT INVENTION

The present invention relates to a method of making a composition containing graphene oxide that can be applied to a porous membrane, and a method of making a filter in which the composition provides a graphene oxide membrane on the filter. The present invention also relates to a composition containing graphene oxide that can be applied, and a filter and a filtration cartridge.

### BACKGROUND OF THE PRESENT INVENTION

A membrane consisting of layers of graphene oxide sheets, a two-dimensional material, is ideal for separating dissolved species based on molecular size (hydrodynamic radius). Due to the tortuous path that the fluid must follow, however, the permeance of such membranes is not sufficient. One approach to improve the permeance is through the introduction of additional porosity and reducing the size of the sheets, thus reducing the tortuosity. This is conventionally done using a high ratio of modifying agent to graphene oxide, resulting in dilute graphene oxide suspensions and requiring the product to be centrifuged and washed to remove the excess modifying agent.

Challenges remain in the preparation of industrially-relevant large-scale graphene oxide membranes that are capable of long-term stable performance and are resistant to redispersion of hydrophilic graphene oxide sheets (delamination) in the high-shear filtration environment.

### SUMMARY OF THE PRESENT INVENTION

An embodiment of the present invention relates to a method of making a composition containing graphene oxide sheets, wherein the method includes:
an adding step that includes adding a modifying agent to a graphene oxide feed suspension containing graphene oxide sheets, hereinafter referred to as the feed suspension, to form the composition; and
a modifying step that includes modifying the composition under elevated temperature conditions so that the modifying agent reacts with the graphene oxide sheets to create imperfections in the graphene oxide sheets, wherein progress of the reaction is stopped by reducing the temperature of the composition so the composition stabilises and can be applied to a substrate to form a filter having a graphene oxide membrane.

A benefit of the method of the present invention is that any unreacted amount of the modifying agent in the composition does not need to be removed before the composition can be applied to a porous substrate to form a filtration membrane. That is to say, the composition does not need to undergo additional purification steps to remove excess modifying agent from the composition.

The terms “creating imperfections” or “create imperfections” in the sheets embraces a number of possible modifications to the sheets, including reducing the size of the sheets, and creating defects in the sheets such as creating holes in the sheets, and increasing the size of pre-existing holes in the sheets. A hole in the sheet is where the carbon-carbon lattice structure, at a molecular level, is disrupted. The introduction of imperfections in the graphene oxide sheets means that when the composition forms a membrane on a porous substrate, the membrane has a higher permeance than if no imperfections were present in the graphene oxide sheets.

The size of the sheets and the extent of pre-existing holes in the sheets in the feed suspension need not be precisely prescribed or analysed at a nanoscale level. In any event, we have found that the graphene oxide sheets may have a maximum diameter in the range of 4,000 to 40,000 nm. The pre-existing holes may be any size that is smaller than the sheets, and may for example, have a maximum diameter up to 500 nm.

Some sheets may have no pre-existing holes, whereas other sheets may have any number of pre-existing holes. For example, the number of pre-existing holes in the size range up to 500 nm may be from 1 to 10.

Although the composition can be applied using a variety of techniques, one of the benefits of the present invention is that the composition can be printed or applied to a substrate which enables products to be made at high speed.

Another embodiment of the present invention relates to a composition containing graphene oxide sheets, in which the graphene oxide sheets have been modified by reacting with a modifying agent to create imperfections in the graphene oxide sheets at an elevated temperature wherein progress of the reaction is stopped by reducing the temperature of the composition to form a stable composition that can be applied to a substrate to form a graphene oxide filtration membrane.

The composition described in the paragraph immediately above may include any one or a combination of the features of the method of making the composition described herein. Similarly, the method of making the composition may include any one or a combination of the features of the printable composition described herein.

Another embodiment of the present invention relates to a method of making a membrane for filtering a fluid, wherein the method includes:
applying an adhesive additive to a porous substrate; and
applying the composition to the porous substrate to form a filter having a membrane containing graphene oxide, wherein the composition has been made in accordance with the method described herein, and the adhesive additive facilitates bonding of the composition to the substrate.

Yet another embodiment of the present invention relates to a filter for filtering a fluid, the filter having a porous substrate, the composition as described herein applied to the substrate, and an adhesive additive that facilitates bonding of the composition to the porous substrate.

### DETAILED DESCRIPTION

The term “membrane”, “filtration membrane” and “graphene oxide membrane” and variations thereof may be used interchangeably and embrace layers of the graphene oxide sheets on a substrate.

Although it is ideal that the membrane be continuous over the substrate, it is possible that small areas of no graphene oxide sheets are present, similarly, there may be small areas of little to no overlapping of the graphene oxide sheets on account of mechanism by which the composition is applied to the substrate.

### Graphene Oxide Feed Suspension

A suitable graphene oxide feed suspension is commercially available from various suppliers, including: (i) William Blythe Ltd of the United Kingdom who sell a 10 mg/mL graphene oxide aqueous suspension having a variable sheet size under the trade name “GO Graphene”; (ii) ACS Materials, LLC of the United States of America, California, who sell a 10 mg/mL suspension and a 5 mg/mL graphene oxide water or ethanol graphene oxide suspension under the description “Single Layer Graphene Oxide Dispersion”; and (iii) Sigma-Aldrich who sell a 10 mg/mL graphene oxide water suspension under the trade name 906999.

When the feed suspension has been obtained from the sources mentioned in the paragraph above, the concentration of impurities in the feed suspension does not have a detrimental impact on the ability to form a composition that can be printed, or on the performance of the composition as a filtration membrane. That is to say, the feed suspension may have an impurity concentration over a broad range. The concentration of impurities can be measured in various ways, one of which is measuring the electrical conductivity of the feed suspension. For example, the feed suspension may have an electrical conductivity as high as 2,500 μS/cm, or even higher. However, it is preferred that the graphene oxide feed suspension may have a conductivity of less than 2,500 μS/cm, or even be substantially free of impurities.

In one example, the feed suspension may have an electrical conductivity of less than 600 μS/cm, suitably a conductively of less than 550 μS/cm, and even more suitably a conductively of less than 500 μS/cm. Even more ideally, the graphene oxide suspension has an electrical conductivity of less than 450 μS/cm. When the feed suspension has an electrical conductivity of 450 μS/cm or less, the feed suspension is effectively free from any disruptive effects of salts, ions or other impurities.

The graphene feed suspension may be prepared in a preliminary process step by combining a dry graphene oxide with water and mixing. Similarly, the graphene feed suspension may be prepared in a preliminary process step by combining dry graphite oxide with water and mixing. Dry graphene oxide includes a cake material with some proportion of graphene oxide and the balance being water.

The graphene feed suspension may contain graphene oxide at a concentration in the range of 0.1 to 15 wt %, and suitably in the range of 0.5 to 10 wt %, and more suitably in the range of 0.5 to 8 wt %, even more suitably in the range of 1 to 5 wt %, and yet even more suitably in the range of 1 to 2 wt %.

### Modifying Agent

The modifying agent may be added to the feed suspension in amounts so that all of, or nearly all of, the modifying agent reacts with the graphene oxide sheets.

The modifying agent may be added to the feed suspension at a mass ratio of modifying agent to the graphene oxide mass in the feed suspension in a range of less than or equal to 1000 to 1, and suitably at a mass ratio of less than 500 to 1, or more suitably at a mass ratio of less than 250 to 1, or even more suitably at a mass ratio of less than 100 to 1, 50 to 1, 25 to 1, 15 to 1, 12 to 1, 10 to 1, 9 to 1, 8 to 1, 7 to 1, 6 to 1. The addition of the modifying agent may include mixing the modifying agent and the feed suspension in a composition of 10 to 3 parts modifying agent to 1 part graphene oxide of the feed suspension, and suitably mixing 5 parts modifying agent to 1 part graphene oxide of the feed suspension. In one example, the modifying agent may be added to the feed suspension in amounts of 4 parts modifying agent to 1 part graphene oxide of the feed suspension. In another example, the modifying agent may be added to the feed suspension in amounts of 3 parts modifying agent to 1 part graphene oxide of the feed suspension. In yet another example, the modifying agent may be added to the feed suspension in amounts of 2 parts modifying agent to 1 part graphene oxide of the feed suspension. In yet a further example, the modifying agent may be added to the feed suspension in amounts of 1 part modifying agent to 1 part of the graphene oxide of the feed suspension.

The ratio of modifying agent to graphene oxide in the composition may impact on the period of mixing of the mixing step. For instance, when less modifying agent is added to the composition, the period of mixing may be increased to effectively create imperfections in the sheets. Conversely, the period of mixing required to create imperfections may be reduced when a higher amount of modifying agent is added. The method may include controlling the ratio of modifying agent added to the graphene oxide of the feed suspension based on a predetermined period of the mixing.

The method may include controlling the period of mixing based on predetermined ratio of modifying agent being added to the graphene oxide of the feed suspension. Suitably, the modifying step may be carried out for a period in the range of 0.5 hr to 7 hr, although mixing can be carried out for any period. For example, in a range from 0.5 hr to 6 hrs, preferably from 1 hr to 6 hrs, preferably from 2 hrs to 5 hrs, preferably from 2 hrs to 4 hrs and even more preferably for approximately 3 hrs and so forth.

The modifying agent may be any suitable modifying agent including, for example hydrogen peroxide (H₂O₂). Hydrogen peroxide may be provided as an aqueous solution, and suitably a solution having hydrogen peroxide concentration in the range of 20 to 50 wt %, and more suitably at a concentration in the range of 25 to 45 wt %, and even more suitably in a concentration range of 30 to 40 wt %. Suitably the modifying agent is a hydrogen peroxide solution at a mass concentration in the range of 30 to 35 wt %.

Examples of other possible modifying agents include peracetic acid, benzoyl peroxide, sodium perborate, ammonium hydroxide, or alkali hydroxides such as sodium hydroxide and potassium hydroxide. In one example, the modify agent may include hydrogen peroxide in combination with any one of peracetic acid, benzoyl peroxide, sodium perborate, ammonium hydroxide, or alkali hydroxides such as sodium hydroxide and potassium hydroxide.

In one example, adding the modifying agent to the feed suspension is performed disjunctively, in which the mixing step is carried out after the modifying agent has been added to the composition.

In another example, at least part of the modifying agent may be added to feed suspension whilst the mixing is carried out.

The method may include heating the composition during at least part of the modifying step. The method may also include controlling the temperature of the composition based on a predetermined period of the mixing.

The modifying step may include heating the composition to a temperature in the range of, for example, from 50° C. to about 200° C., or preferably about 80° C. to about 150° C., or preferably in the range of 50 to 98° C., and ideally in the range of 80 to 90° C. The modifying step may be performed for a period in the range of, for example, about 1 hour to about 10 hours, or from approximately 2 hours to 6 hours, or approximately 4r hours during which the composition is stirred or agitated.

The method may also include a step of cooling the composition to stop the progress of the reaction of the modifying agent and the graphene oxide sheets. The cooling step may include reducing the temperature of the composition to below 50° C. In one example, the cooling step may include reducing the temperature of the composition to a temperature below 45° C. In another example, the cooling step may include reducing the temperature of the composition to a temperature in the range of the 15 to 45° C., and suitably to a temperature in the range of 25 to 45° C.

The mixing step may also be carried out under increased pressure conditions. For example, under evaporation of solvent, modifying agent, or by way of gas production such as carbon dioxide, or carbon monoxide. The increased pressure may be an elevated pressure in the range of 5 to 15 bar (absolute). Suitably, the increased pressure of the mixing step may be a pressure in the range of 7.5 to 12 bar (absolute).

The mixing step may be carried out in any suitable vessel for heating and mixing the composition. The vessel may also be closed such as, for example, an autoclave. The autoclave enables the mixing/agitation, heating and pressurisation to be carried out in a single vessel simultaneously.

There are a number of parameters that can be used for measuring when the reaction between the modifying agent and the graphene oxide sheets has progressed far enough so the temperature of the composition can be reduced to form a stable composition. For example, carbon dioxide may be released by the reaction of the modifying step, and the amount of carbon dioxide produced may be a measure of the extent of the reaction of the modifying agent with graphene oxide sheets. Other parameters or characteristics that can be measured include any one or a combination of (i) viscosity of the composition, (ii) colour and colour changes of the composition, and (iii) infrared spectrum analysis of the composition. Viscosity may be measured, for example, by taking an aliquot and analysing the sample. In another example, viscosity may be measured as a function of the power required to mix the composition by a mixer. For instance, a measure of the power consumed by an electromagnetic mixer or the power consumed by an electrical motor may be a function of the viscosity of the composition, and in turn, the extent of the reaction of the modifying agent with the graphene oxide sheets.

Generally speaking, we have found that viscosity initially increases during the reaction between the modifying agent and the graphene oxide sheets, and then decreases, indicating that the reaction has progressed far enough to be stopped. Moreover, we have found that the viscosity increases and then decreases back to a viscosity approximate to the original viscosity at the start of the mixing step.

The method may include measuring viscosity of the composition to determine when to stop the progress of the reaction. For example, the cooling step may be carried out when the viscosity of the composition reaches a maximum, or has started reducing from a maximum viscosity, to stop the reaction between the modifying agent and the graphene oxide.

The reaction may be stopped by reducing the temperature of the composition when the viscosity is within 15% of a maximum viscosity, suitably within 10% of the maximum viscosity, more suitably within 5% of the maximum viscosity, and even more suitably within 1 to 5% of the maximum viscosity of the composition.

The reaction may be stopped by reducing the temperature of the composition when the viscosity reaches a maximum or has started reducing from a maximum viscosity.

The modifying step may be carried out for at least 1 to 5 hours after a maximum in the viscosity of the composition has occurred before the cooling step, and preferably the modifying step is carried out for at least 2 to 4 hours after a maximum in the viscosity of the composition has occurred before the cooling step.

In addition, the reaction has also progressed far enough when reducing the temperature of the composition forms a stable composition and the composition can be applied to a substrate to form the filtration membrane.

Once the modifying agent has reacted with the graphene oxide, for example, after a predetermined period has lapsed, the composition may be cooled. In the event of any pressure build up, the pressure may also be released.

The method may be carried out without removing, if present, any surplus modifying agent from the composition after the cooling step. That is to say the composition is a stable without removing the modifying agent from the composition after the cooling step.

One of the purposes of the modifying agent is to increase the number of pores or holes in the graphene oxide sheets. The modifying agent will react with the graphene oxide sheets to introduce new holes or further increase existing holes to provide a distribution of different sizes of nanopores. The nanopores can have pores having a maximum diameter from 1 nm, from 2 nm, from 3 nm, 4 nm, 5 nm, up to 10 nm, up to 20 nm, up to 50 nm, up to 100 nm or more.

### Crosslinking Additive

The method may include adding a crosslinking additive to the composition, wherein the additive can form crosslinks between the graphene oxide sheets. The crosslinks may be the result of any form of suitable bonding including covalent bonds, ionic bonds, electrostatic bonds, van der Waals bonds and so forth.

The method may include applying a crosslinking additive to a membrane of the composition after the composition has been applied to the substrate and dried. A suitable crosslinking additive that can be added may be a cationic additive such as polyDADMAC.

The purpose of the crosslinking additive is to minimise delamination of the graphene oxide sheets and improve membrane integrity. Without wishing to be bound by theory, the crosslinking additive forms cross-links between the graphene oxide sheets. In practice, the crosslinking additive forms extendible tethers between the sheets that allows for some change in spatial separation between the sheets, but generally speaking, the crosslinking additive makes the spatial separation and therefore the rejection and filtering properties of the graphene oxide membrane more consistent across different conditions. For instance, in the absence of the crosslinking additive, we believe that the rejection of the graphene oxide composition, when dried, which relates to the spacing between the graphene sheets, increases significantly as acidity increases and similarly the rejection of the graphene oxide membrane decreases significantly as the alkalinity increases.

However, the changes in rejection are far more stable when the crosslinking additive is added to the composition (or applied to the composition after the composition after the composition has been applied to the substrate). In other words, a benefit of the crosslinking additive is that the composition provides more reliable rejection properties over greater range of pH conditions.

The term “rejection” of the composition relates to the spacing between the graphene oxide sheets in a membrane. That is to say, rejection of the graphene oxide composition is more consistent across a range of pH when a crosslinking additive is used.

### Epoxy-Containing Crosslinking Additive

The crosslinking additive may be a molecule or polymer with an epoxide group that reacts with and bonds to graphene oxide sheets. In addition to an epoxide group, the crosslinking additive may also have a second reactive group that can self-react to crosslink graphene oxide sheets. For instance, the second reactive group may be an alkoxysilane that can form covalent bonds with the alkoxysilane group of another crosslinking additive bound to another sheet of graphene oxide. An example of a molecule having an epoxide group and a hydrolysable silanol group is 3-glycidyloxypropl trimethoxy silane, which is also known as GLYMO.

The crosslinking additive may have an epoxide group and in addition, have a cationic group that forms a non-covalent or ionic bond with the graphene oxide. For instance, the cationic group may be trimethylammonium. An example of a molecule having an epoxide group and trimethylammonium is glycidyltrimethylammonium chloride, which is also known as GTAC.

The crosslinking additive may also have multiple epoxide groups, such as a diepoxide that bonds with the graphene oxide. Example of molecules having multiple epoxide groups include: poly(ethylene glycol) diglycidyl ether, 1,4—butanediol diglycidyl ether, and poly(dimethylsiloxane) that is diglycidyl ether terminated. These examples are also examples of diepoxide molecules.

The epoxide containing crosslinking additives may be added to the composition. That is, prior to the composition being added to the substrate. An example of the epoxide containing crosslinking additive is GLYMO. The method may include activation of the crosslinking additive after the composition has been applied to the substrate. In one example, activation can be carried out by heating the substrate and composition on the substrate above 50° C. for at least 1 hour, and suitably to a temperature of 75° C. for at least 2 hours. In another example, a catalyst such as aluminium acetylacetonate, can be applied to the composition on the substrate as a solution, for example 1 g/L in 2-propanol.

### Cationic Polymer Crosslinking Additive

The crosslinking additive may also include a cationic polymer. In one example, the cationic polymer may have quaternary functionality by a quaternized nitrogen atom. For instance, quaternized ammonium.

The cationic polymer can also use a polymer compound with at least one quaternized ammonium structure within the principal chain. Examples of structural units that can be incorporated within the principal chain and contain an ammonium structure include pyridinium, piperidinium, piperazinium and aliphatic ammonium structures. Examples of other structural units that can be incorporated within the principal chain include methylene, ethylene, vinylene and phenylene units, and ether linkages. A specific example of this type of cationic polymer is poly(N,N-dimethyl-3,5-methylenepiperidinium chloride).

Examples of cationic polymers having quaternary functionality include cationic polyvinyl alcohol, cationic polyacrylamide, cationic poly-urea-ammonium-ether, cationic hydroxyethyl cellulose, cationic guar.

An example of a suitable cationic polymer is a modified polyvinyl alcohol incorporating one or more quaternary ammonium groups, such as GOHSENX™ K, from Mitsubishi Chemical, Japan.

Another example includes guar or hydroxyethyl cellulose that have been cationically modified, for example JAGUAR OPTIMA, which is available from Solvay S. A. (Belgium). Structures of these polymers may be represented as shown in Table 1.

TABLE 1
Cationic polymers

| Description | Structure |
|---|---|
| Cationic guar hydroxypropyltrimonium halide, such as a chloride | 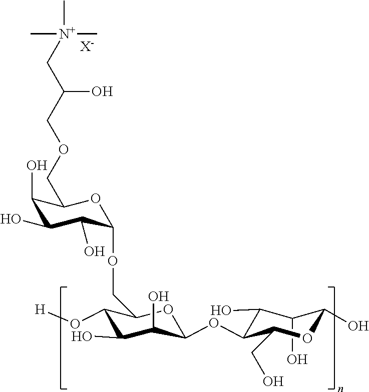 |
| Cationic Guar gum, 2-hydroxy-3- (trimethylammonio)propyl ether, chloride Commercially available from Solvay under the trade name Jaguar-Optima | 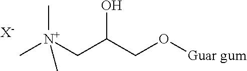 |
| Cationic hydroxyethylcellulose Commercially available from Sigma- Aldrich under the trade name Polyquaterium-10 | 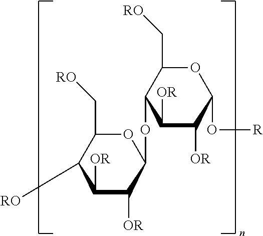 |
| | 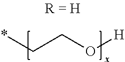 |
| | 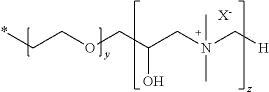 |
| Cationic Polyacrylamide with a quaternized nitrogen atom | 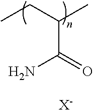 |
| | 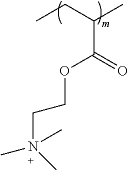 |
| Cationic polyDADMAC with a quaternized nitrogen atom Commercially available from Sigma- Aldrich under the trade name Polyquaterium-6 | 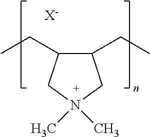 |
| Cationic poly(epihalohydrin-co- dimethylamine) with a quaternized nitrogen atom, such as epichlorohydrin | 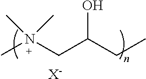 |
| Cationic poly(allylammonium halide), such as chloride, with a quaternized nitrogen atom | 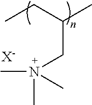 |
| Cationic poly urea-ammonium-ether Poly[bis(2-Haloethyl) ether-alt-1,3- bis[3-(dimethylamino)propyl]urea] quaternized Commercially available from Sigma- Aldrich under the trade name | 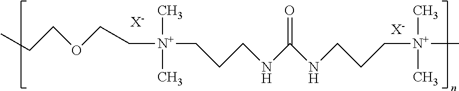 |
| Polyquaterium-2 | |
| Cationic polyacrylamide, very | -AM(x)-DAC(y)-DMC(z)-DADMAC(a)- |
| strongly cationic, high molecular | x + y + z + a = 1 and 0 < y + z + a < 1 and 0 < x < 1 |
| weight | That is say, the cationic polyacrylamide has at least one AM group |
| Commercially available from Sinofloc | and at least one DAC/DMC/DADMAC group. |
| under the trade name SINOFLOC 680 | The structures of |
| | AM, DAC, DMC and DADMAC are shown in Table 2 |
| Cationic polyacrylamide, high | -AM(x)-DAC(y)-DMC(z)-DADMAC(a)- |
| cationic charge, ~70% | x + y + z + a = 1 and 0 < y + z + a < 1 and 0 < x < 1 |
| Commercially available from | That is say, the cationic polyacrylamide has at least one AM group |
| Hydroflux under the trade name HB- | and at least one DAC/DMC/DADMAC group. |
| 2705 | The structures of AM, DAC, DMC and DADMAC are shown in Table 2 |

In Table 1, the symbol X⁻ may be any halide or salts, such as chlorides, bromides and iodides.

Examples of other possible cationic polymers include polymer compounds with a tertiary ammonium structure such as:
a) poly(ethyleneimine) halide or salt, such as hydrochloride,
b) poly(4-vinylpyridinium halide), for instance the halide may be chloride, or
c) poly(2-vinylpyridinium halide), for instance the halide may be chloride.

Examples of other possible cationic polymers include polymer compounds with an aliphatic quaternary ammonium structure:
d) poly(vinyltrialkylammonium halides) such as poly(vinyltrimethylammonium chloride), SUBSTITUTE SHEETS (RULE 26)
e) poly(allyltrialkylammonium halides) such as poly(allyltrimethylammonium chloride), or
f) poly(oxyethyl-1-methylenetrialkylammonium halides) such as poly(oxyethyl-1-methylenetrimethylammonium chloride).

Examples of other possible cationic polymers include polymer compounds with a quaternary ammonium structure substituted with an aromatic hydrocarbon group:
g) poly(vinylbenzyltrialkylammonium halides) such as poly(vinylbenzyltrimethylammonium chloride).

Examples of other possible cationic polymers include polymer compounds with a quaternary ammonium structure incorporated within a heterocyclic structure:
h) poly(N-alkyl-2-vinylpyridinium halides) such as poly(N-methyl-2-vinylpyridinium chloride),
i) poly(N-alkyl-4-vinylpyridinium halides) such as poly(N-methyl-4-vinylpyridinium chloride),
j) poly(N-vinyl-2,3-dialkylimidazolium halides) such as poly(N-vinyl-2,3-dimethylimidazolium chloride),
k) poly(N-alkyl-2-vinylimidazolium halides) such as poly(N-methyl-2-vinylimidazolium chloride), or
l) poly(oxyethyl-1-methylenepyridinium halide).

Examples of other possible cationic polymers include acrylic polymer compounds with an ammonium structure:
m) poly(2-hydroxy-3-methacryloyloxypropyltrialkylammonium halides) such as poly(2-hydroxy-3-methacryloyloxypropyltrimethylammonium chloride), or
n) poly(3-acrylamidepropyltrialkylammonium halides) such as poly(3-acrylamidepropyltrimethylammonium chloride).

Examples of other possible cationic polymers include a group of polymers comprising cationic monomers, as either homopolymers or copolymers, consisting of quaternized vinylpyrrolidone, dimethylaminoethyl methacrylate, methacrylamidopropyl trimethylammonium chloride, diallyldimethyl ammonium chloride (which is also known as DADMAC), allyl trimethyl ammonium chloride and copolymer of acrylamidopropyltrimonium chloride and acrylamide, cationic copolymer of vinylpyrrolidone and of a quaternized vinylimidazole, and mixtures thereof. These monomers may also be co-polymerised with any suitable non-cationic monomer or monomers, including but not limited to acrylamide.

The structure of these cationic monomers may be represented as shown in Table 2.

TABLE 2
Monomers that may be used in the production of cationic polymers

| Cationic monomer | Structure |
|---|---|
| Acrylamide (AM) | 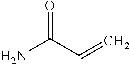 |
| Dimethylaminoethyl methacrylate | 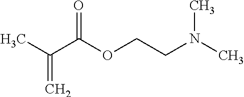 |
| [2- (Acryloyloxy)ethyl] trimethylammonium halide such as chloride (DAC) | 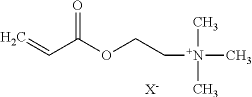 |
| [2- (Methacryloyloxy)ethyl] trimethylammonium halide such as chloride (DMC) | 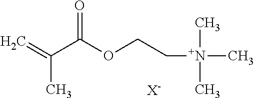 |
| Methacrylamidopropyl trimethylammonium halide such as chloride | 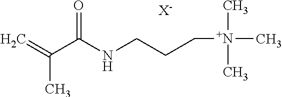 |
| Diallyl dimethyl ammonium halide such as chloride (DADMAC) | 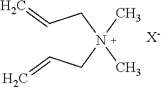 |
| Acrylamidopropyltrimethyl ammonium halide such as chloride | 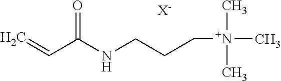 |
| Quaternised vinylimidazole | 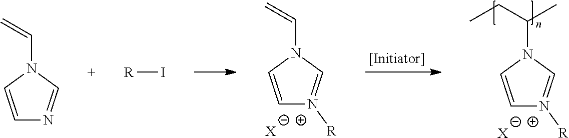 |

In Table 2, the symbol X⁻ may be any halide or salts, including chlorides, bromides and iodides,

Diamine crosslinking additive

The additive may include a molecule or polymer having at least two reactive amine groups so to form crosslinks between the graphene oxide sheets during the process of drying the composition. That is to say, the crosslinking additive may be a diamine polymer.

An example of a suitable diamine polymer is polyethyleneimine (PEI). Examples of suitable diamine molecules include: ethylene diamine, propylene diamine, butane diamine, hexamethylene diamine, p-phenylenediamine, and o-phenylenediamine.

The crosslinking additive may be selected from a group comprising: i) a polymer having at least one epoxide group, ii) a molecule having at least one epoxide group, iii) a cationic polymer having at least one quaternary ammonium group, iv) a polymer having at least two amine groups, v) a molecule having at least two amine groups.

### Reductant

The method may also include adding a reductant to the composition. The reductant may be used to partially reduce the graphene oxide and therefore change the interlayer spacing in the resulting graphene oxide membrane.

The reductant may include any suitable reductant including hydrazine, sodium borohydride, citrates, and alkali hydroxides such as sodium hydroxide and potassium hydroxide. In addition to a reductant, sulfuric acid may also be added.

The reducing solution may include any reductant containing hydroxyl groups that are miscible with the intermediate solution. Examples of the constituents include phenolic compounds, alcohol compounds or carboxylic compounds. The reductant may be benzenic. For instance, polyphenols, catechols, and so forth.

### pH Adjustment

The process may also include a step of adjusting the pH to make the composition stable depending on the crosslinking additives added to the composition. For example, the composition has a pH in the range of 8 to 12, and suitably approximately 10.5.

The step of adding the additive may also include mixing the composition until homogeneous.

### Adhesive Additives and Filtration Membrane

The method of making the filtration membrane may include applying an adhesive additive to the substrate.

An adhesive additive may be applied to improve the bonding of the composition to the porous substrate, decreasing delamination of the graphene oxide from the porous substrate. The step of applying the adhesive additive may occur before the composition has been applied to the substrate. For example, an adhesive additive may be dip coated onto the substrate or applied by a printing method such as microgravure printing.

The adhesive additive may include a polymer having a N(nitrogen) active cation. For instance, a quaternized nitrogen atom.

The adhesive additive may include a polymer having a cyclic structure having a N(nitrogen) substitution that provides an active cation.

The adhesive additive may include a quaternary ammonium group.

The adhesive additive may be a cationic polymer such as any one of those listed in Table 1 or Table 2 above, or described in paragraph [0057] to [0061]. That is to say, the adhesive additive may act as the crosslinking additive and vice versa. For example, the cationic polymer may be polydiallyldimethylammonium chloride (polyDADMAC).

Examples of other possible cationic polymers include: i) polymer compounds with a tertiary ammonium structure, ii) polymer compounds with an aliphatic quaternary ammonium structure, iii) polymer compounds with a quaternary ammonium structure substituted with an aromatic hydrocarbon group, iv) polymer compounds with a quaternary ammonium structure incorporated within a heterocyclic structure, and v) polymers including acrylic polymer compounds with an ammonium structure.

For instance, the adhesive additive may be a cationic polymer such as a modified polyvinylalcohol incorporating at least one quaternary ammonium group. An example of a cationic polyvinylalchohol that is commercially available is sold under the trade name GOHSENXT™ K Series by Mitsubishi Chemical.

Examples of other cationic polymers that may be used as the adhesive additive having quaternary functionality include: cationic polyvinyl alcohol, cationic polyacrylamide, cationic poly-urea-ammonium-ether, cationic hydroxyethyl cellulose, or cationic guar.

### Dopamine

For example, the adhesive additive may include dopamine or at least a cyclic form a dopamine which is formed by the polymerisation of dopamine.

When the adhesive additive includes dopamine, suitably the method includes initiating polymerisation of the dopamine prior to the adhesive additive being applied to the substrate. Table 3 below is representative sequence of the reaction that may occur during the initial polymerisation of the dopamine to polydopamine. Polymerisation of dopamine may include dissolving dopamine in an aqueous ethanol solution and oxidising it, for example, by reacting with periodate to from polydopamine (PDA).

TABLE 3

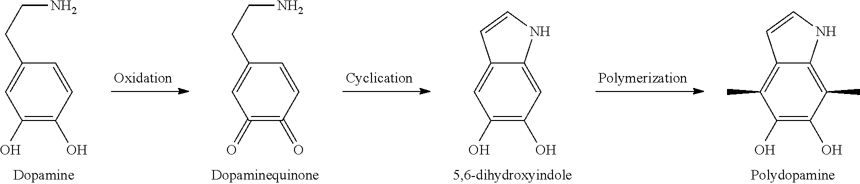

### Porous Substrate

The porous substrate may be made of any suitable polymer.

The porous substrate may be made of polymer including, one or a combination of polyolefin, polyvinyl, polyamide, polycellulose, polysulfone, polyethersulfone, polyethylene, polypropylene, polyethyleneterephthlate, polyester, polydimethyl siloxane, polytetrafluoroethylene, polyacrylonitrile, polyvinyl chloride.

In one example, the porous substrate may include polyvinylidene difluoride.

It is also possible that the porous substrate may be a metallic substrate or a ceramic substrate.

Examples of suitable substrates are commercially available from the following.
(a) Synder Filtration of the United States of America under the trade name Synder Bx
(b) Solecta Inc. (USA) under the trade name PVDF 400
(c) RisingSun Membrane Technology (Beijing) Co., Ltd. (China) as MF020
(d) Membrane Technologies Inc. (USA) as PVDF HVF
(e) Beijing OriginWater Technology Co., Ltd. (China) as Origin Water (MF022)
(f) TOMAC Corporation (Japan), under the trade name TCV-050/38A

### Setting the Permeance

The method may also include setting the permeance of the filtration membrane before first use to an extent permitted by the crosslinking additive.

Setting the permeance may include treating the filtration membrane with a solution of known pH for a period. The treating step may include submerging the filtration membrane in a bath of the solution. The solution may be an acid solution.

In the case of an acid solution, we believe the spaces between graphene sheets reduces which will reduce the permeance of the filtration membrane. Similarly, in the case of an alkaline solution, we believe space between graphene sheets will increase and hence the permeance of the filtration membrane will increase. The extent to which the acid or alkaline treatment can adjust the spacing between the sheets, or the swelling between the sheets, is restricted by the crosslinking additive. Hence the degree of change brought about by the permeance setting step is also subject to the extent to which the crosslinks between the sheets can flex.

Setting the permeance may include treating the membrane for a period in the range of 3 to 20 minutes, suitably in the range of 5 to 10 minutes, and even more suitably for at least 5 minutes.

Setting the permeance may include treating the membrane with a solution having a pH ranging from 8.5 to 12, and suitably in the range of the 9 to 10.

Setting the permeance may include treating the filtration membrane with a NaOCl (bleach) solution of known pH for a period. Setting the permeance may include treating the filtration membrane with a bleach solution containing 10,000 mg/L of NaOCl at pH 4 for a period of 30 minutes.

### Viscosity and Surface Tension

The method may include adjusting either one or a combination of viscosity and/or surface tension of the composition to enable more effective printing. For example, polyphenol, surfactants or organic solvents may be added to the composition.

### Chlorine Resistance

The method of making the membrane for filtering may include making the membrane chlorine resistant. Similarly, the method of making the composition may include making the composition chlorine resistant. By providing chlorine resistance, the membrane is resistant to degradation caused by sodium hypochlorite (NaOCl) also known as bleach, which is used for cleaning the membranes to remove fouling deposits that decrease the performance of the membrane. Provided the membrane has sufficient pH resistance, the cleaning process can be performed at any pH. The cleaning may be done at a pH from 4 to 12. At low pH, the active species is chlorine (Cl₂) or hypochlorous acid, HOCl, and at higher pH the active species is hypochlorite, OCl⁻. The chlorine resistance of the membrane is limited by the choice of adhesive additive and crosslinking additive. Both the adhesive additive and the crosslinking additive, if used, must be chlorine resistant for the membrane to be chlorine resistant. Examples of chlorine resistant combinations include (a) GOHSENX-K (adhesive additive) and polyDADMAC (crosslinking additive), and (b) polyDADMAC (adhesive additive) and glymo (crosslinking additive). Examples of non-chlorine resistant combinations include (a) polydopamine (adhesive additive) and PEI (crosslinking additive), and (b) GOHSENX-K (adhesive additive) and PEI (crosslinking additive). Chlorine resistance can be estimated by exposure of a membrane to a solution of sodium hypochlorite at a specified pH for a specified amount of time (expressed as ppm.h), and then measuring the permeance and rejection of the membrane in a cross-flow filtration test. Typically, a chlorine resistant membrane is one that can withstand being exposed up to 120,000 ppm.h of chlorine prior to performance degradation. Specifically, the membrane may be resistant to chlorine in a range of 10,000 to 100,000 ppm.h and has a rejection of equal to or greater than 90% when rejection is tested using a Rose Bengal probe molecule or equivalent.

### BRIEF DESCRIPTION OF THE DRAWINGS

Embodiments of the present invention will now be described with reference to the accompanying Figures which may be summarised as follows.

FIG. 1 is a block diagram of the steps for making a composition according to a preferred embodiment and a method of making a filter by applying the composition to a substrate.

FIG. 2 is a block diagram of the steps for making a composition according to another embodiment and a method of making a filter by applying the composition to a substrate.

FIG. 3 is a block diagram of the steps for making a composition according to yet another embodiment and a method of making a filter by applying the composition to a substrate.

FIG. 4 is a schematic cross-sectional view of the filter that can be made according to an embodiments shown in FIGS. 1 to 3.

### DESCRIPTION OF THE DRAWINGS

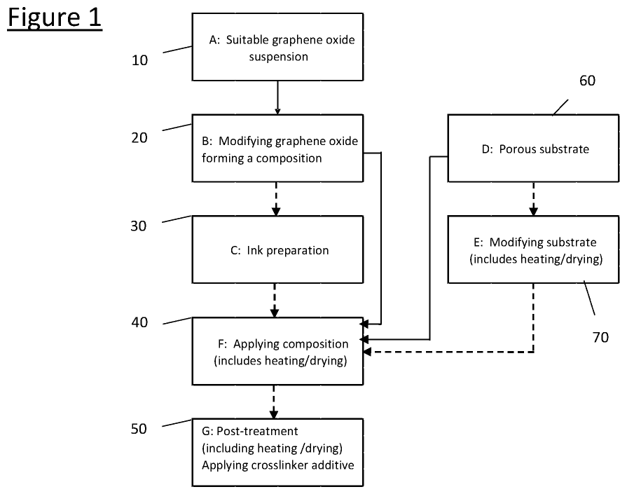

With reference to FIG. 1, the suitability of a graphene oxide feed suspension for making a composition that can be applied such as printed to form a graphene oxide filtration membrane 90 on the substrate 110 is a function of many variables. One possible variable is the level or concentration of impurities in the feed suspension. Step 10 of FIG. 1 can include selecting a feed suspension and optionally determining the suitability of the feed suspension by assessing the level of impurities in the feed suspension. One method for assessing the level of impurities is measuring the electrical conductively of the feed suspension. Step 10 of FIG. 1 may optionally also include preparing a suitable feed suspension, including combining dry graphite oxide with water and mixing, or combining dry graphene oxide with water and mixing. For example, a feed suspension may be prepared by combining a graphene oxide cake containing 43±5 wt % graphene oxide with water and mixing. Water may be added to the feed suspension to adjust the graphene oxide concentration into a range of 0.1 to 15 wt %.

Step 20 of FIG. 1 can include treating the feed suspension to create imperfections in the graphene oxide. Specifically, Step 20 includes adding an active modifying agent to the feed suspension to form a composition, and mixing the composition under elevated temperature and then reducing the temperature of the composition to stop progress of the reaction between the modifying agent and the graphene oxide so as to form a stable composition. In this situation all of, or nearly all of, the modifying agent may have reacted with the graphene oxide sheets. Step 20 can include determining the amount of modifying agent(s) to be added to the feed suspension, including determining a desired mass ratio of modifying agent to the graphene oxide sheets in the feed suspension. In addition, Step 20 can be carried out under heated conditions, which may or may not be accompanied by pressurised conditions, to increase the reaction rate between the modifying agent(s) and the graphene oxide. The period of mixing the composition may be reduced by increasing the temperature and pressure conditions of Step 20. Conversely the period of mixing the composition may be increased by lowering the temperature to ambient temperature.

In a situation in which the modifying agent comprises hydrogen peroxide in isolation with no other modifying/active agent, we have found that a 30 wt % hydrogen peroxide solution can be added to the feed suspension at a ratio of equal to or less than 5 parts hydrogen peroxide to 1 part suspension. In this embodiment the suspension comprises approximately 1 mg/mL of graphene oxide. When used in this range, the hydrogen peroxide is reacted with the graphene oxide for sufficient reaction time. These conditions provide a graphene oxide with the required permeance, avoids subsequent separation of excess modifying agent from the feed suspension, and can be readily scaled up into commercial operating batches. Step 20 may be carried out in a batch operation.

Step 20 of FIG. 1 may include determining when the reaction between the modifying agent and the graphene oxide has progressed far enough by measuring, for example, any one or a combination of the viscosity of the composition, colour and colour changes of the composition, and infrared spectrum analysis of the composition. The reaction between the modifying agent and the graphene oxide may also produce a gas, such as carbon dioxide, and determining whether the reaction has progressed far enough may be determined by measuring the amount of the gas produced during the mixing step.

The composition may then be treated in optional Step 30 of FIG. 1 to facilitate the composition being used as a printable composition using microgravure printing machines or other application methods. Properties of the composition, such as viscosity and surface tension may then be measured and adjusted in Step 30. For example, the surface tension may be controlled using surfactants such as Triton-available from DOW Inc. In another example, the viscosity of the composition may also be controlled by adding polyphenol and/or ethanol. Adjusting the viscosity and/or the surface tension enables the composition to be applied as a filtration membrane using high speed printing machinery, such as gravure printing or micro-gravure printing. In other words, not only is the composition suitable for making filtration membranes, but in addition, the composition can be applied at a manufacturing speed at a large scale.

One of the benefits of the method shown in FIG. 1 is that no cross-linking materials need to be added to the composition prior to applying the composition to the substrate.

Step 60 of FIG. 1 can include selecting a porous substrate 110 such as a porous film including polymeric, metallic or ceramic films. Selecting an appropriate substrate, is typically based on the desired permeance and flexibility.

Step 70 of FIG. 1, which is optional, can include modifying the substrate 110 to improve the adhesion of the graphene oxide membrane 90 to the porous substrate 110. For example, an adhesive additive 100, such as either one or a combination of, adhesives such as polyDADMAC, GOHSENXT™ K and dopamine can be applied to the substrate in Step 70, and dried. The rate at which the adhesive dries may be increased by heating once the additive has been applied to the substrate. The adhesive additive 100 may be applied using dip coating, printing, spraying, or other suitable techniques.

Step 40 of FIG. 1 can include applying and preferably printing the composition prepared in Steps 20 and/or 30 to the substrate 110 to form a filter 200 having a graphene oxide membrane 90 provided by the composition. This may be done by a gravure printing machine including micro-gravure printing, or other techniques such as dip coating, rod coating, knife coating, blade coating, vacuum filtration or spraying to form a membrane 90 of the composition on the substrate 110. Step 40 may include drying the composition which may be done in ambient conditions. However ideally, the rate at which the composition dries may be increased by exposure to radiant heat or by convection, for example, by means of a stream of heated air. The adhesion of the composition to the substrate 110 is less prone to degradation as a result of the adhesive additive 100 applied in Step 70.

Step 50 of FIG. 1 is optional and can include a post treatment of the filter 200 by applying a crosslinking additive 120 such as polyDADMAC to the dried graphene oxide membrane 90. The crosslinking additive 120 provides a level of pH resistance to the graphene oxide membrane 90. The term “pH resistance” refers to the rejection of the filter 200 being less variable over a broader pH range than if no crosslinking additive 120 was added to the composition. Step 50 of FIG. 1 may optionally also include a permeance-enhancing or permeance setting step by exposing the membrane 90 to a solution of sodium hypochlorite for a period of time. For example, the membrane 90 can be submerged in a 10 g/L solution of sodium hypochlorite for a period of 30 minutes (5,000 ppm.h) to increase the permeance.

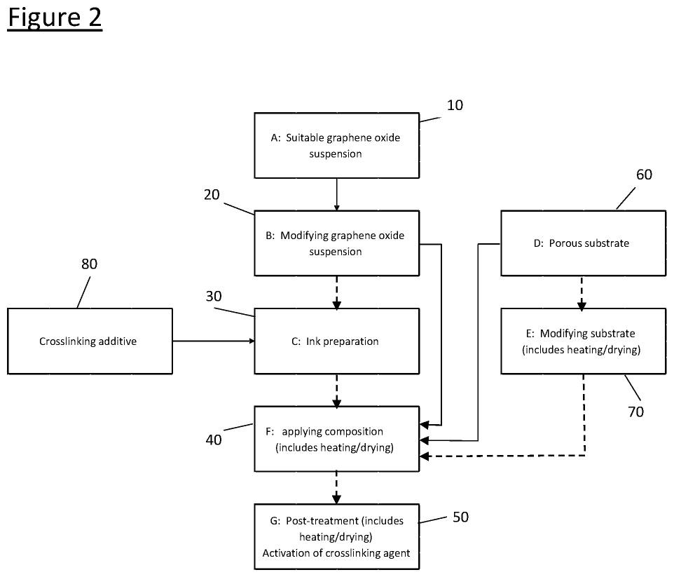

FIG. 2 is a block diagram of an embodiment for making a composition that can be applied to a substrate, such as printed, to form a graphene oxide filtration membrane 90 on the substrate 110. FIG. 2 has particular steps relating to the addition of epoxy containing crosslinker 120 to the composition prior to the composition being applied to the substrate, and subsequent activation of the crosslinker in a post-treatment step after the composition has been applied to the substrate. Step 10 of FIG. 2 can include the same procedures described above in relation to Step 10 of FIG. 1. Ideally, the feed suspension has or is adjusted to have a graphene oxide concentration into a range of 0.1 to 15 wt %.

Step 20 of FIG. 2 can include the same procedures described above in relation to Step 20 of FIG. 1. That is Step 20 includes treating the feed suspension to create imperfections in the graphene oxide to form a composition. For instance, Step 20 can include adding an active modifying agent to the feed suspension to form a composition, and mixing the composition under elevated temperature and then reducing the temperature of the composition to stop progress of the reaction between the modifying agent and the graphene oxide to form a stable composition. In this situation all of, or nearly all of, the modifying agent may have reacted with the graphene oxide. In addition, Step 20 of FIG. 2 can include determining whether the reaction can be stopped to form a stable composition.

For instance, Step 20 of FIG. 2 may include determining when the reaction between the modifying agent and the graphene oxide has progressed far enough by measuring, for example, any one or a combination of the viscosity of the composition, colour and colour changes of the composition, and infrared spectrum analysis of the composition. The reaction between the modifying agent and the graphene oxide may also produce a gas, such as carbon dioxide, and determining whether the reaction has progressed far enough may be determined by measuring the amount of the gas produced during the mixing step.

The composition may then be treated in Step 30 of FIG. 2 to facilitate the composition being used as a printable composition using microgravure printing machines or other application methods. For instance, viscosity and surface tension may then be measured and adjusted in Step 30 by adding surfactants such as Triton-available from DOW Inc. The viscosity of the composition may also be controlled by adding polyphenol and/or ethanol. Adjusting the viscosity and/or the surface tension enables the composition to be applied as a filtration membrane using high speed printing machinery, such as gravure printing or micro-gravure printing.

In addition, Step 80 of FIG. 2 may optionally include adding crosslinking additives 120 to the composition such as either one or a combination of epoxide containing crosslinkers, such as GLYMO or GTAC (glycidyl trimethylammonium chloride). These crosslinking additives 120 provide stabilization to the rejection properties of the filter 120 over a broader range of pH than if no crosslinking additive was included. At a structural level the crosslinkers 120 manage the spatial separation between the graphene oxide sheets.

Step 60 of FIG. 2 can include the same procedures described above in relation to Step 60 of FIG. 1. Specifically, Step 60 can include selecting a porous substrate 110 such as a porous film including polymeric, metallic or ceramic films.

The method of FIG. 2 may optionally include Step 70 which includes modifying the substrate 110 to improve the adhesion of the graphene oxide membrane 90 to the porous substrate 110. For example, an adhesive additive 100, such as either one or a combination of, adhesives such as polyDADMAC, GOHSENXT™ K and dopamine can be applied to the substrate in Step 70, and dried. The rate at which the adhesive dries may be increased by heating once the adhesive additive 100 has been applied to the substrate. The adhesive additive 100 may be applied using dip coating, printing, spraying, or other suitable techniques.

Step 70 of FIG. 2 can include the same steps as Step 70 described in relation to FIG. 1. For instance, Step 70 of FIG. 2 can include applying the composition, such as printing, that has been prepared in Steps 20 or 30 to the substrate to form a filter 200 having a graphene oxide membrane 90 provided by the composition. This may be done by a gravure printing machine including micro-gravure printing, or other techniques such as dip coating or spraying so as to form a membrane of the composition on the substrate.

Step 40 may include drying the composition which may be done in ambient conditions.

The method of FIG. 2 may optionally include Step 50 which can include a post treatment step in which the epoxide containing crosslinking additive 120, such as GLYMO, of Step 30 are activated to complete the crosslinking between the graphene oxide sheets. In one example, activation can be carried out by heating the substrate and composition on the substrate above 50° C. for at least 1 hour, and suitably to a temperature of 75° C. for at least 2 hours. In another example, a catalyst such as aluminium acetylacetonate (1 g/L in 2-propanol) can be applied to the graphene oxide membrane by dip-coating, gravure printing, microgravure printing, or rod coating. For dip-coating, a coupon of the graphene oxide membrane 200 was submerged in a bath of the catalyst solution for a period of 5 minutes, after which the membrane 200 was removed from the bath and dried at ambient temperature without washing. Step 50 of FIG. 2 can also include a permeance-enhancing step of exposing the membrane 200 to a solution of sodium hypochlorite for a period of time. For example, the membrane 200 can be submerged in a 10 g/L solution of sodium hypochlorite for a period of 30 minutes (5,000 ppm.h) to increase the permeance.

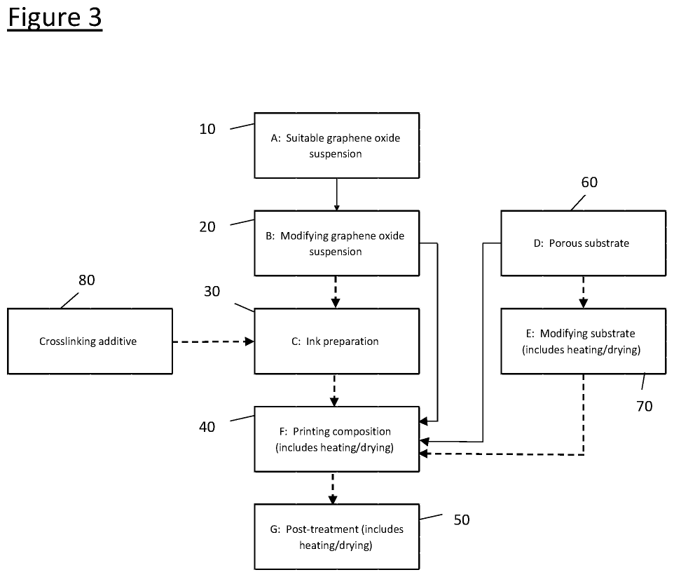

FIG. 3 is a block diagram of an embodiment for making a composition that can be applied to a substrate, such as printed, to form a graphene oxide filtration membrane 90 on a porous substrate 110. FIG. 3 has particular steps relating to the addition of diamine crosslinkers to the composition prior to the composition being applied to the substrate. Step 10 of FIG. 3 can include the same procedures described above in relation to Step 10 of FIG. 1. Ideally, the feed suspension has or is adjusted to have a graphene oxide concentration into a range of 0.1 to 15 wt %.

Step 20 of FIG. 3 can include the same procedures described above in relation to Step 20 of FIG. 1. That is Step 20 includes treating the feed suspension to create imperfections in the graphene oxide to form a composition. For instance, Step 20 can include adding an active modifying agent to the feed suspension to form a composition, and mixing the composition under elevated temperature and then reducing the temperature of the composition to stop progress of the reaction between the modifying agent and the graphene oxide so as to form a stable composition. In which case all of, or nearly all of, the modifying agent may have reacted with the graphene oxide. In addition, Step 20 of FIG. 2 can include determining whether the reaction can be stopped to form a stable composition as outline in Step 20 of FIG. 1.

For instance, Step 20 of FIG. 2 may include determining when the reaction between the modifying agent and the graphene oxide has progressed far enough by measuring, for example, any one or a combination of the viscosity of the composition, colour and colour changes of the composition, and infrared spectrum analysis of the composition. The reaction between the modifying agent and the graphene oxide may also produce a gas, such as carbon dioxide, and determining whether the reaction has progressed far enough may be determined by measuring the amount of the gas produced during the mixing step.

The composition may or may not then be treated in Step 30 of FIG. 3 to facilitate the composition being used as a printable composition using gravure printing machines including microgravure or other application methods. Step 3 may not be required depending on the inherent properties of the composition. If required, viscosity and surface tension may then be measured and adjusted in step C by adding surfactants such as Triton-available from DOW Inc. The viscosity of the composition may also be controlled by adding polyphenol and/or ethanol. Adjusting the viscosity and/or the surface tension enables the composition to be applied as a filtration membrane using high speed printing machinery, such as gravure printing or microgravure.

In addition, Step 80 of FIG. 3 can include adding crosslinking additives 120 containing diamine, such as PEI (polyethyeleneimine), prior to application of the composition to the substrate 110. Diamine crosslinkers provide stabilization to the rejection properties of the filter 200 over a broader range of pH.

Step 60 of FIG. 3 can include the same procedures described above in relation to Step 60 of FIG. 1 or 2. Specifically, step 60 can include selecting a porous substrate 110 such as a porous film including polymeric, metallic or ceramic films.

Step 70 of FIG. 3 can include modifying the substrate 110 to improve the adhesion of the graphene oxide to the porous substrate as described in relation to FIG. 1 or 2. For example, an adhesive additive 100, such as either one or a combination of polyDADMAC, GOHSENXT™ K and dopamine can be applied to the substrate 110 in step E, and dried. The rate at which the adhesive additive 100 dries may be increased by heating once the adhesive additive 100 has been applied to the substrate. The adhesive additive 100 may be applied using dip coating, printing, spraying, or other suitable techniques.

Step 40 of FIG. 3 can include the same steps as Step 40 described in relation to FIGS. 1 and 2. For instance, Step 40 of FIG. 2 can include printing or applying the composition prepared in step 30 to the substrate to form a filter 200 having a graphene oxide membrane 90 provided by the composition. This may be done by a gravure printing machine such as a microgravure printing machine, or other techniques such as dip coating or spraying so as to form a membrane 90 of the composition on the substrate 110. Step 40 may include drying the composition which may be done in ambient conditions.

Step 50 of FIG. 1 can include a permeance-enhancing step of exposing the membrane to a solution of sodium hypochlorite for a period of time. For example, the membrane 90 can be submerged in a 10 g/L solution of sodium hypochlorite for a period of 30 minutes (5,000 ppm.h) to increase the permeance.

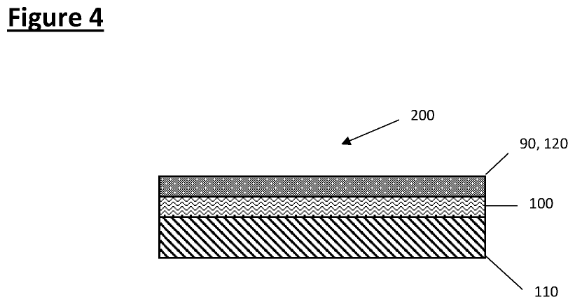

FIG. 4 is a schematic cross-section view of the filter including a graphene oxide membrane 90 applied to a substrate 110. The substrate 110 can be selected in accordance with Step 60 and optionally modified in accordance with Steps 70 by applying an adhesive additive 100. The graphene oxide membrane 90 that is applied to the substrate 110 includes the suspension or composition of Step 10, and the composition may optionally be further characterised by the Steps 20 and 30. The composition applied to the substrate may include a crosslinking additive 120 which is suitably applied to a dried graphene oxide membrane 90 formed on the substrate 110 in accordance Step 50. In addition, or alternatively, the crosslinking additive 120 may be added to the composition containing the graphene oxide prior to the composition being applied to the substrate 110, such as in Steps 30 and 80.

### Examples:—Example 1

In this example, a composition and a filtration membrane were made in accordance with the Steps of FIG. 1. The permeance and the rejection of this filtration membrane were measured, in accordance with the membrane performance test described below, to be 14 L/m²/h/bar and 96% respectively. These measurements are included in Table 3A.

A composition containing modified graphene oxide (8.6 g/L), i.e., the GO composition, was prepared by reacting graphene oxide (10 g/L) with hydrogen peroxide (5:1 mass ratio H₂O₂:GO) for 6.0 hr at 90° C. in an autoclave.

A porous substrate membrane, which was commercially available under the trade name Solecta PVDF 400, was prepared by printing a thin film of GOHSENX™ K onto the substrate using a microgravure printer to act as an adhesive additive. GOHSENX™ K was in the form of a 50% aqueous ethanol (4.3 g/L) solution which was applied at a density of approximately 0.1 g/m². After drying, a thin film of the modified GO composition was applied to the treated porous membrane support using a microgravure printer at a density of approximately 0.09 g/m². The modified GO composition contained 4.3 g/L of modified graphene oxide. After drying, a thin film of crosslinking additive comprising polyDADMAC (average M_{w}<100,000, Sigma-Aldrich product code 522376) was applied at a density of approximately 0.01 g/m² to the graphene oxide membrane using a microgravure printer, from a 50% aqueous ethanol solution containing 5 g/L polyDADMAC.

### Example 2

In this example, a composition and a filtration membrane were made in accordance with the Steps of FIG. 2. The permeance and the rejection of this filtration membrane were measured, in accordance with the membrane performance test described below, to be 27 L/m²/h/bar and 95% respectively. These measurements are included in Table 3A.

A composition containing modified graphene oxide (8.6 g/L) was prepared by reacting graphene oxide (10 g/L) with hydrogen peroxide (5:1 mass ratio H₂O₂:GO) for 6.0 h at 90° C. in an autoclave. 100 mL of the modified graphene oxide suspension was diluted to 5 g/L by adding 70 mL of 2-propanol. 0.43 g of glymo, (3-glycidyloxypropyl)trimethoxysilane, was added to the diluted suspension (dropwise), while the suspension was being vigorously stirred.

A porous membrane substrate was prepared by printing a thin film of an adhesive additive comprising GOHSENX™ K onto a substrate at a density of approximately 0.1 g/m². The substrate comprised Solecta PVDF 400 and an aqueous solution of GOHSENX™ K (5 g/L) was applied using a microgravure printer. After drying, a thin film of the modified graphene oxide composition was applied to the treated porous membrane substrate using a microgravure printer at a density of approximately 0.09 g/m². After drying, the membrane was immersed in a solution of aluminium acetylacetonate (1 g/L in 2-propanol) for 5 minutes which acts as a catalyst for the glymo to form crosslinks between the graphene sheets. The membrane was then removed from the catalyst solution and dried at ambient temperature without washing.

### Example 3

In this example, a composition and a filtration membrane were made in accordance with the Steps of FIG. 3. The permeance and the rejection of this filtration membrane were measured, in accordance with the membrane performance test described below, to be 34 L/m²/h/bar and 96% respectively. These measurements are included in Table 3A.

A composition containing modified graphene oxide (8.6 g/L) was prepared by reacting graphene oxide (10 g/L) with hydrogen peroxide (5:1 mass ratio H₂O₂:GO) for 5.5 h at 90° C. in an autoclave. Red grape skin polyphenol (5.36 g) was added to 2.92 L of the composition whilst being stirred vigorously at a rate of 6000 rpm. The polyphenol was added slowly in stages and the composition was sheared for 15 minutes. The composition was then heated to 75° C. and stirred at 100 rpm for 1 hour. A crosslinking additive comprising polyethyleneimine (PEI, branched, average M_{w}˜800, Sigma-Aldrich product code 408719) was added at a 1:16 mass ratio to the graphene oxide composition.

An adhesive additive containing a dopamine solution (2000 mg/L in 50% aqueous ethanol) was prepared, and polymerisation was initiated by adding sodium periodate (at 4000 mg/L) and the reaction occurred for 10 minutes to form a polydopamine (PDA). A porous substrate was then prepared by applying a thin film of the polymerising solution using a microgravure printer. After drying, a thin film of the composition at a density of 0.09 g/m² was applied to the treated porous substrate using a microgravure printer.

### Example 4

In this example, a composition and a filtration membrane were made in accordance with the Steps of FIG. 1.

A graphene oxide membrane can also be formed on a hollow fibre porous support, such as an ultrafiltration or microfiltration hollow fibre made of polyvinylidene fluoride, polypropylene, polyacrylonitrile, polysulphone, or ceramic.

The fibre is dipped in an adhesive additive comprising GOHSENX™ K (4 g/L in 50% aqueous ethanol) for 1 minute, then dried for 1 hour in a dehydrator at 70° C. (application of adhesive).

A composition containing modified graphene oxide (8.6 g/L) was prepared by reacting graphene oxide (10 g/L) with hydrogen peroxide (5:1 mass ratio H₂O₂:GO) for 5.5 h at 90° C. in an autoclave, then diluting to 1 g/L graphene oxide with water. The adhesive-coated substrate was then submerged in the composition and connected to a vacuum pump. A vacuum is applied to the adhesive-coated membrane until the permeate is colourless, indicating that a graphene oxide film had formed on the fibre substrate, preventing further passage of graphene oxide. The graphene oxide-coated fibre was then dried overnight at 70° C. in a dehydrator.

A crosslinking additive was then applied to the film of graphene oxide by being dipped in a solution of polyDADMAC (5 g/L in 50% aqueous ethanol) for 1 minute, then dried for 2 hours in a dehydrator at 70° C.

The treated hollow fibre was then submerged in a solution of Rose Bengal (˜200 mg/L) and a vacuum applied. The area of the fibre was unknown so the permeance could not be calculated, but the concentration of Rose Bengal in the feed and permeate showed that the rejection was 99%.

### Filtration Membrane Performance Testing

We have tested the permeance and rejection of the filtration membranes mentioned in Examples 1, 2 and 3 above, and several other samples of filtration membranes that have been made in accordance with the embodiments shown in FIGS. 1, 2 and 3. Results of the tests are summarised in Tables 3A, 3B and 3C.

The testing procedure included flat samples of the filtration membranes being held in a cross-flow mode at 2 bar transmembrane pressure using Rose Bengal (4,5,6,7-tetrachloro-2′,4′,5′,7′-tetraiodofluorescein disodium salt) as the probe molecule (200-300 mg/L) at pH 9 (unless otherwise specified) using a Sterlitech CF042 cell. The membrane area was 42.1 cm². Rejection was calculated from the concentration of Rose Bengal in the feed and the permeate according to the following equation:

$$Rejection = [ 1 - ( R {B}_{permeate} / R {B}_{feed} ) ] \times 100 \%$$

Where:
RB_{feed}=concentration of Rose Bengal in the feed
RBₚₑᵣₘₑₐₜₑ=concentration of Rose Bengal in the permeate

The concentration of Rose Bengal was measured by UV-visible spectrophotometry, using the Beer-Lambert Law to convert the absorbance at 549 nm to concentration in mg/L.

The flow rates of the feed and the permeate were measured gravimetrically for calculation of the permeance using the following equation:

$$Permeance ( L / {m}^{2} / h / bar ) = {V}_{permeate} / ( A \times t \times P )$$

Where:
V=volume of permeate (L)
A=area of membrane (in)
t=time (h) during which permeate was collected
P=transmembrane pressure (bar)

NaOCl post-treatment was carried out by exposing membrane coupons to a 10,000 mg/L solution of NaOCl for 30 minutes.

Chlorine resistance was evaluated by exposing membrane coupons to a solution of NaOCl at the specified pH for a period of time. For example, 10,000 ppm.h=1 hour of exposure to a 10,000 mg/L NaOCl solution. Following chlorine exposure, the membrane coupon was rinsed with deionised water and then tested using Rose Bengal as above.

TABLE 3A
Rejection of Rose Bengal with various combinations of adhesive and cross-linker

| | | | | | | Made in |
|---|---|---|---|---|---|---|
| | | Adhesive additive | Crosslinking | Permeance | Rejection | accordance |
| Sample | Substrate | added to substrate | additive | L/m²/h/bar | % | with: |
| 1a | Solecta PVDF400 | GOHSENX-K | polyDADMAC | 14 | 96% | FIG. 1 |
| 2a | Solecta PVDF400 | GOHSENX-K | glymo | 27 | 95% | FIG. 2 |
| 3a | Solecta PVDF400 | polyDADMAC | glymo | 23 | 99% | FIG. 2 |
| 4a | Solecta PVDF400 | polyDADMAC | GOHSENX-K | 34 | 98% | FIG. 1 |
| 5a | Solecta PVDF400 | Polydopamine (PDA) | PEI | 34 | 96% | FIG. 3 |
| 6a | Synder Bx | GOHSENX-K | polyDADMAC | 12 | 99% | FIG. 1 |

The measurements in Table 3A shows that the filtration membranes made in accordance with FIGS. 1, 2 and 3 with combinations of adhesive and crosslinking additives have viable rejections of equal to, or greater than 90%, and in the range from 96% to 99%. In addition, the permeance is measured to range from 12 to 34 L/m²/h/bar.

TABLE 3B
Improved permeance after NaOCl post-treatment and maintaining high rejection

| | | | | | | | Made in |
|---|---|---|---|---|---|---|---|
| | | Adhesive additive | Crosslinking | Post- | Permeance | Rejection | accordance |
| Sample | Substrate | added to substrate | additive | treatment | L/m²/h/bar | % | with |
| 7a | Solecta | GOHSENX-K | glymo | None | 27 | 95% | FIG. 2 |
| | PVDF400 | | | | | | |
| 7b | Solecta | GOHSENX-K | glymo | NaOCl | 37 | 99% | FIG. 2 |
| | PVDF400 | | | | | | |
| 8a | Solecta | GOHSENX-K | polyDADMAC | None | 14 | 96% | FIG. 1 |
| | PVDF400 | | | | | | |
| 8b | Solecta | GOHSENX-K | polyDADMAC | NaOCl | 31 | 94% | FIG. 1 |
| | PVDF400 | | | | | | |
| 9a | Solecta | polyDADMAC | glymo | None | 14 | 98% | FIG. 2 |
| | PVDF400 | | | | | | |
| 9b | Solecta | polyDADMAC | glymo | NaOCl | 20 | 94% | FIG. 2 |
| | PVDF400 | | | | | | |
| 10a | Synder Bx | GOHSENX-K | polyDADMAC | None | 12 | 99% | FIG. 1 |
| 10b | Synder Bx | GOHSENX-K | polyDADMAC | NaOCl | 35 | 93% | FIG. 1 |

Table 3B includes measurements that compare the filtration membranes without a post treatment and filtration membranes that include a bleach post treatment. The combinations of substrate, adhesive additive and crosslinking additive show that the filtration membranes were resistant to the chlorine in the bleach post treatment, whilst maintaining viable rejection rates of greater than 90%. In addition, the bleach post treatment was shown to increase the permeance of the filtration membranes.

TABLE 3C
Stable performance across pH range when cross-linker is included in membrane

| | | | | | | | Made in |
|---|---|---|---|---|---|---|---|
| | | Adhesive | Crosslinking | | Permeance | Rejection | accordance |
| Sample | Substratet | additive | additive | pH | L/m²/h/bar | % | with |
| 11a | Solecta | Polydopamine | None | 4 | 9 | 96% | FIG. 3 |
| | PVDF400 | (PDA) | | | | | |
| 11b | Solecta | Polydopamine | None | 7 | 14 | 85% | FIG. 3 |
| | PVDF400 | (PDA) | | | | | |
| 11c | Solecta | Polydopamine | None | 9 | 28 | 45% | FIG. 3 |
| | PVDF400 | (PDA) | | | | | |
| 12a | Solecta | Polydopamine | PEI | 4 | 28 | 98% | FIG. 3 |
| | PVDF400 | (PDA) | | | | | |
| 12b | Solecta | Polydopamine | PEI | 7 | 28 | 98% | FIG. 3 |
| | PVDF400 | (PDA) | | | | | |
| 12c | Solecta | Polydopamine | PEI | 9 | 33 | 97% | FIG. 3 |
| | PVDF400 | (PDA) | | | | | |

Samples 11a, 11b and 11c were made in accordance with one of the embodiments shown in FIG. 3, in which no crosslinking additive was added to the composition and no crosslinking additive was applied to the graphene oxide membrane. Moreover, the results show that the filtration membranes of the samples 11a to 11c were suspectable to swelling with changes in pH which caused both the permeance and rejection to fluctuate considerably. However, the inclusion of crosslinking additive PEI, in samples 12a, 12b and 12c stabilised rejection and permeance of these samples.

Table 4 includes samples 17 to 23 of membranes that were prepared in accordance with the procedure outlined in Example 1 and FIG. 1 and tested for pH resistance. The membranes were prepared by coating a porous substrate comprising PVDF from TOMAC Corporation (Japan) with an adhesive additive comprising a GOHSENX™ K aqueous solution. A thin film of the adhesive additive, at a density of approximately 0.1 g/m², was applied to the substrate using a microgravure printer and dried. A thin film of the graphene oxide composition was then applied at a density of approximately 0.09 g/m² using a microgravure printer. The membranes were then dip coated with aqueous solutions of various crosslinking additives as shown in Table 4 at a density of approximately 0.001 g/m², and the permeance and rejection of the membranes were tested under particular pH conditions. No crosslinking additive was added to sample 24 which provided a Control.

The membranes were tested for pH resistance in the cross-flow apparatus Sterlitech CF042, using a solution of Rose Bengal, at pH 4, pH 7 and pH 10. The permeance and the rejection were measured. The data set out in Table 4 shows that all of the cationic polymers tested as crosslinking additives produced membranes with higher rejection than the Control that had no crosslinking additive at each of the pH values. That is to say, the crosslinking additives had a pronounced effect on the ability of the membranes to continue to perform under various pH conditions, specifically from pH values ranging from 4 to 10. The difference was most pronounced at pH 10, which is indicative of layers of the graphene oxide sheets swelling, which decreases rejection. The permeance increased as the rejection decreased.

TABLE 4

| | Crosslinking additive | | | | | | | | |
|---|---|---|---|---|---|---|---|---|---|
| | | | Conc | Permeance (L/m²/h/bar) | | | Rejection (%) | | |
| Sample | Trade name | Class | (g/L) | pH 4 | pH 7 | pH 10 | pH 4 | pH 7 | pH 10 |
| 13 | SINOFLOC 680* | Cationic | 1 | 6.7 | 8.1 | 10.9 | 96.3% | 95.0% | 91.9% |
| | | polyacrylamide | | | | | | | |
| 14 | Polyquaternium-2* | Cationic poly urea- | 5 | 6.9 | 8.6 | 10.0 | 99.3% | 99.1% | 98.4% |
| | | ammonium-ether | | | | | | | |
| 15 | Hydroflux HB-2705* | Cationic | 1 | 9.0 | 10.4 | 12.9 | 98.6% | 97.9% | 95.8% |
| | | polyacrylamide | | | | | | | |
| 16 | Polyquaternium-10* | Cationic hydroxyethyl | 1 | 11.0 | 13.7 | 16.3 | 95.8% | 92.9% | 76.7% |
| | | cellulose | | | | | | | |
| 17 | Jaguar Optima* | Cationic guar | 1 | 11.6 | 16.1 | 19.8 | 91.9% | 86.4% | 65.5% |
| 18 | Polyquaternium-6* | Cationic polyDADMAC | 5 | 13.7 | 17.5 | 25.1 | 99.5% | 99.1% | 98.8% |
| 19 | PEI | Polyamine | 5 | 9.8 | 12.8 | 17.6 | 98.7% | 97.6% | 95.7% |
| 20 | N/A | Control | n/a- | 15.8 | 18.8 | 34.3 | 90.0% | 62.1% | 36.1% |

*indicates quaternary functionality

In summary, when the crosslinking additive is a cationic polymer, and is preferably one selected from a group consisting of: Cationic polyacrylamide, Cationic poly urea-ammonium-ether, Cationic polyacrylamide, Cationic hydroxyethyl cellulose, Cationic guar, Cationic polyDADMAC, or is a polyamine, the filter has a rejection value greater than 90% under acid conditions. For the same crosslinking additives, the filter has a rejection value greater than 90% under alkaline conditions.

In addition, when the crosslinking additive is a cationic polymer, and is preferably one selected from a group consisting of: Cationic polyacrylamide, Cationic poly urea-ammonium-ether, Cationic polyacrylamide, Cationic hydroxyethyl cellulose, Cationic guar, Cationic polyDADMAC, or is a polyamine, the filter has a permeance value (L/m²/h/bar) less than 15.8 under acidic conditions, and preferably a permeance value in the range of 6.7 to 13.7. For the same crosslinking additives, the filter has a permeance value (L/m²/h/bar) less than 34.4 under alkaline conditions, and preferably a permeance value in the range of 10.0 to 25.1 under alkaline conditions.

Samples 21 to 27 of a filter were prepared in accordance with Example 1 and FIGS. 1, and a Control, sample 28, was also tested for chlorine resistance. A First set of the samples 21 to 27 were treated with a solution of sodium hypochlorite (5 g/L) at pH 4 or at pH of 10 for 2 hours, that is 10,000 ppm.h of NaOCl. The membranes were then rinsed with deionised water to remove residual NaOCl, and then tested in the cross-flow apparatus using a solution of Rose Bengal, at pH 4 and pH 10. For comparison, another set of the membranes, namely the Second Set of samples 21 to 27 were made in accordance with Example 1 and FIG. 1, and Control 24 was prepared and tested without being exposed to chlorine, that is 0 ppm.h of NaOCl. The permeance and rejection of the Second Set of samples 21 to 27 were tested in the cross-flow apparatus using a solution of Rose Bengal at pH 4 and pH 10.

Table 5 comprises performance data of the First and Second Sets of samples 21 to 28 at a pH of 10. The data of the samples having a cationic polymer as crosslinking additive produced membranes with higher rejection than the Control which had no crosslinking additive after exposure to chlorine, such as sodium hypochlorite. The data also showed that the membranes having cationic polymers with quaternary ammonium groups as crosslinking additives produced membranes with improved resistance to degradation by chlorine. Specifically, the first set of samples 1 to 13 had permeance values after exposure to 10,000 ppm.h of NaOCl ranging from 13.7 to 29.8 (L/m²/h/bar) when measured using the probe molecule Rose Bengal in the cross-flow apparatus at a pH of approximately 10, i.e. under alkaline conditions. Under alkaline conditions, i.e. a pH of approximately 10, the rejection was greater than 90% with a cross linking additive selected from cationic polyacrylamide, Cationic poly urea-ammonium-ether, Cationic polyacrylamide, polyDADMAC. By comparison, the permeance of the second set of samples 21 to 28 which were not exposed to chlorine had a permeance values ranging from 10.9 to 25.1 (L/m²/h/bar). That is to say, the permeance, of the membranes, after exposure to 10,000 ppm.h of NaOCl increased in range from 2.8 to 5.3 (L/m²/h/bar) according to the Rose Bengal cross flow under alkaline conditions, whilst rejection ranged from 45.1% to 98.5%, and suitably 61.8% to 98.5%, and even more suitably from 90% to 98.5%.

TABLE 5
Chlorine resistance of membranes with quaternary ammonium crosslinkers at pH 10

| | | | | Second Set of samples | | First Set of samples | |
|---|---|---|---|---|---|---|---|
| | | | | Filtration at pH 10 after | | Filtration at pH 10 after | |
| | Crosslinking additive | | | 0 ppm · h | | 10,000 ppm · h | |
| Sample | | | Conc | Permeance | Rejection | Permeance | Rejection |
| numbers | Trade name | Class/Description | (g/L) | (L/m²/h/bar) | % | (L/m²/h/bar) | % |
| 21 | SINOFLOC 680* | Cationic polyacrylamide | 1 | 10.9 | 91.9% | 13.7 | 90.7% |
| 22 | Polyquaternium-2* | Cationic poly urea- | 5 | 10.0 | 98.4% | 14.1 | 93.2% |
| | | ammonium-ether | | | | | |
| 23 | Hydroflux HB-2705* | Cationic polyacrylamide | 1 | 12.9 | 98.4% | 16.3 | 91.6% |
| 24 | Polyquaternium-10* | Cationic hydroxyethyl | 1 | 16.3 | 76.7% | 19.7 | 61.8% |
| | | cellulose | | | | | |
| 25 | Jaguar Optima* | Cationic guar | 1 | 19.8 | 65.5% | 25.1 | 45.1% |
| 26 | Polyquaternium-6* | Cationic polyDADMAC | 5 | 25.1 | 98.8% | 29.8 | 98.5% |
| 27 | PEI | Polyamine | 5 | 17.6 | 95.7% | 49.1 | 19.3% |
| 28 | None | Control | — | 34.3 | 36.1% | 51.3 | 20.5% |

*indicates quaternary functionality

In summary, when the crosslinking additive is a cationic polymer selected from cationic polyacrylamide, cationic poly urea-ammonium-ether, cationic hydroxyethyl cellulose, cationic guar and cationic polyDADMAC, and when exposed to 10,000 ppm.h of chlorine, the filter has rejection values ranging from 90% to 98.5% under alkaline conditions. In this instance, the filter has permeance values ranging from 13.7 to 29.8 (L/m²/h/bar) when measured using the probe molecule Rose Bengal in the cross-flow apparatus.

When the filter has a crosslinking additive including a cationic polymer and an adhesive additive including GOHSENX-K™, and when exposed to 10,000 ppm.h of chlorine, the filter has a permeance value ranging from 13.7 to 29.8 L/m2/h/bar and a rejection value ranging from 90.7% to 98.5% under alkaline conditions.

Table 6 comprises performance data at pH of 4. The data of the samples having a cationic polymer as crosslinking additive produced membranes with higher rejection than the Control which had no crosslinking additive after exposure to chlorine, such as sodium hypochlorite. The data also showed that the membranes having cationic polymers with quaternary ammonium groups as crosslinking additives produced membranes with improved resistance to degradation by chlorine. Specifically the two far right columns show that permeance values after exposure to 10,000 ppm.h of NaOCl range from 11.0 to 23.8 (L/m²/h/bar) when measured using the probe molecule Rose Bengal in the cross-flow apparatus at a pH of approximately 4, i.e. under acidic conditions. By comparison, the permeance of the Second set of samples 21 to 28, which had not been exposed to chlorine, had permeance values ranging from 10.9 to 25.1 (L/m²/h/bar). The permeance values of the membranes after exposure to 10,000 ppm.h of NaOCl increased by an amount of equal to or less than 10.1 (L/m²/h/bar), and suitably less than 5.0, and suitably by an amount in the range of 1.1 to 4.8 (L/m²/h/bar) according to the Rose Bengal cross flow under acid conditions and rejection values range from 86.9% to 99.2%, and suitably 90% to 99%, and even more suitably from 90% to 97%, and even more suitably still form 90% to 95%.

TABLE 6
Chlorine resistant or membranes with quaternary ammonium cationic crosslinkers at pH 4

| | | | | Second Set of samples | | First Set of samples | |
|---|---|---|---|---|---|---|---|
| | | | | Filtration at pH 4 after | | Filtration at pH 4 after | |
| | Crosslinking additive | | | 0 ppm · h | | 10,000 ppm · h | |
| Sample | | | Conc | Permeance | Rejection | Permeance | Rejection |
| number | Trade name | Class/Description | (g/L) | (L/m²/h/bar) | % | (L/m²/h/bar) | % |
| 21 | SINOFLOC 680* | Cationic polyacrylamide | 1 | 6.7 | 96.3% | 11.3 | 93.3% |
| 22 | Polyquaternium-2* | Cationic poly urea- | 5 | 6.9 | 99.3% | 11.0 | 95.0% |
| | | ammonium-ether | | | | | |
| 23 | Hydroflux HB-2705* | Cationic polyacrylamide | 1 | 9.0 | 98.6% | 13.8 | 93.9% |
| 24 | Polyquaternium-10* | Cationic hydroxyethyl | 1 | 11.0 | 95.8% | 12.1 | 90.9% |
| | | cellulose | | | | | |
| 25 | Jaguar Optima* | Cationic guar | 1 | 11.6 | 91.9% | 13.7 | 86.9% |
| 26 | Polyquaternium-6* | Cationic polyDADMAC | 5 | 13.7 | 99.5% | 23.8 | 99.2% |
| 27 | PEI | Polyamine | 5 | 9.8 | 98.7% | 14.5 | 87.8% |
| 28 | None | Control | — | 15.8 | 90.0% | 20.2 | 88.2% |

*indicates quaternary functionality

In summary, the crosslinking additive is a cationic polymer selected from cationic polyacrylamide, cationic poly urea-ammonium-ether, Cationic hydroxyethyl cellulose, Cationic guar, and cationic polyDADMAC, and when exposed to 10,000 ppm.h of chlorine, the filter has rejection value ranging from 86.9% to 99.2% under acid conditions.

When the cross linking additive is selected from cationic polyacrylamide, cationic poly urea-ammonium-ether, Cationic hydroxyethyl cellulose, and cationic polyDADMAC, and when exposed to 10,000 ppm.h of chlorine the filter has rejection values greater than 90% to 99.2, under acid conditions. The filter has permeance values ranging from 11.0 to 23.8 (L/m²/h/bar) when measured using the probe molecule Rose Bengal in the cross-flow apparatus.

When the filter has a crosslinking additive including a cationic polymer and an adhesive additive including GOHSENXT™ K, and when exposed to 10,000 ppm.h of chlorine, the filter has a permeance value ranging from 11.0 to 23.8 L/m2/h/bar and a rejection value ranging from 86.6% to 99.5% under acidic conditions

When the filter has a crosslinking additive including a diamine polymer with at least two reactive amine groups, and an adhesive additive for adhering the membrane to the porous substrate and the adhesive additive includes GOHSENX™ K, and when exposed to 10,000 ppm.h of chlorine, the filter has a rejection value of at least 85%, and suitably a rejection in the range of 85% to 88% and a permeance value ranging from 13 to 15 L/m2/h/bar, and suitably a permeance value of approximately 14.5 L/m2/h/bar under acid conditions.

In addition, the composition prepared in accordance with Example 1 and FIG. 1 was also prepared to determine the point at which the reaction between a modifying and the graphene oxide sheets had progressed sufficiently far enough so the temperature of the composition can be reduced to form a stable composition. That is to say, all of, or nearly all of, the modifying agent had reacted with the graphene oxide sheets.

The procedure included adding i) 2.5L of graphene oxide at a concentration of 10 g/L and ii) 420 mL of H₂O₂ at a concentration of 30 wt % to an autoclave which was stirred at 500 rpm and heated up to 90° C. at 0.8° C./min, and then held at 90° C. for 7 hours. Once the temperature reached 90° C., samples of the composition was withdrawn at time equals zero hrs. At this point, there had been no appreciable reaction between the graphene oxide and the modifying agent and graphene oxide is regarded as unmodified. Samples of the composition were withdrawn at one hour intervals until the reaction was stopped after 7 hours by turning off the heater and turning on the chiller.

The viscosity of the samples was measured at 20° C. using a Brookfield LVT viscometer. Due to the shear thinning nature of the graphene oxide composition, the reported viscosity is the apparent viscosity at a shear rate of 30 rpm.

Filter membranes were then prepared using the samples of the composition in accordance with Example 1 and FIG. 1 and are labelled as Samples 29 to 36 in Table 7 below. Filter membranes were prepared using TOMAC PVDF for the porous substrate, GOHSENXT™ K for the adhesive additive and polyDADMAC for the crosslinking additive. The Samples 29 to 36 comprised coupons of 42.1 cm² in area and the permeance and rejection of each were tested using a 300 ppm solution of Rose Bengal in a cross-flow apparatus operating at 2 bar.

TABLE 7
Apparent viscosity of unmodified and modified graphene oxide
composition and performance of membranes prepared therefrom

| | Reaction | Apparent | | |
|---|---|---|---|---|
| | time | viscosity | Rejection | Permeance |
| Sample | hr | mPa · s | % | L/m²/h/bar |
| 29 | 0 | 104 | 96.4% | 6.5 |
| 30 | 1 | 830 | 99.5% | 9.6 |
| 31 | 2 | 1800 | N/A | N/A |
| 32 | 3 | 1160 | 99.8% | 8.6 |
| 33 | 4 | 470 | 97.1% | 17.8 |
| 34 | 5 | 170 | 95.5% | 17.8 |
| 35 | 6 | 30 | 96.2% | 17.8 |
| 36 | 7 | <30 | 95.9% | 16.9 |

Table 7 shows that the viscosity increases as the reaction proceeds, up to a maximum after 2 hours of reaction time and thereafter the viscosity decreases. The data shows that a functioning membrane can be produced from any of samples 25 to 32, each having a rejection of Rose Bengal greater than 90%. That is to say, a stable composition was obtained for each. In addition, for the filter to have an increased permeance, the viscosity of the composition has ideally reached and passed a maximum viscosity. A maximum in the viscosity occurred somewhere in between 1 and 3 hours. For instance, a total reaction time of 4, 5, 6 and 7 hrs is preferrable. In other words, the modifying step was carried out for at least 1 to 5 hours after a maximum in the viscosity of the composition has occurred. Suitably, the modifying step was carried out for at least 2 to 4 hours after a maximum in the viscosity of the composition has occurred. In the case of sample 27, the high viscosity of the composition prevented the composition from being printed onto the substrate

The method of making the composition and/or filtration membrane may include optional steps such as the following.

### Optional Steps/Features

This step involves adding and mixing a reducing solution with the GO composition. Specifically, a reducing solution containing an amount of red grape skin polyphenol equal to 25% of the GO mass in the composition can be measured and added to the composition whilst the composition is being mixed/sheared. Typically, 5.36 g of polyphenol is added to the 2.917 L of the composition while stirring vigorously at a rate of 6000 rpm. The polyphenol is added slowly in stages and the composition is mixed for 15 minutes or until the composition is homogeneous and a desired viscosity is achieved.

The composition was then heated to 75° C. and stirred at 100 rpm for 1 hour.

To provide a composition that is conducive to printing, an organic solvent can be added. For example, 100 mL of a graphene oxide composition containing 8.57 g/L of graphene oxide was mixed with 100 mL of ethanol to form a 50% aqueous ethanol suspension. This resulted in changes to viscosity and surface tension that improved the application of the graphene oxide to the porous substrate.

Finally, fine control of the permeance of the substrate was carried out with a NaOCl treatment. Specifically, setting the permeance may include treating the filtration membrane by submerging the substrate in a solution of NaOCl for a period. For example, submerging the substrate in a solution of 10,000 mg/L NaOCl for period of 30 minutes, increased the permeance of a PVDF-GO membrane e.g. from 20 to 30 L/m²/hr/bar.

Those skilled in the art of the present invention will appreciate that many variations and modification can be made to the example described herein without departing from the spirit and scope of the present invention.

In the claim which follows, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1-46. (canceled)

47. A method of making a composition containing graphene oxide sheets, wherein the method includes:
an adding step that includes adding a modifying agent to a graphene oxide feed suspension containing graphene oxide sheets, hereinafter referred to as the feed suspension, to form the composition; and
a modifying step that includes modifying the composition under elevated temperature conditions so that the modifying agent reacts with the graphene oxide sheets to create imperfections in the graphene oxide sheets, wherein progress of the reaction is stopped by reducing the temperature of the composition so the composition stabilises and can be applied to a substrate to form a filter having a graphene oxide membrane.

48. The method according to claim 47, wherein the modifying step includes mixing the composition during at least part of, and suitably during all of, the elevated temperature conditions, and preferably
wherein, the elevated temperature is in the range of from 50° C. o about 200° C., or preferably about 80° C. to about 150° C., or preferably in the range of 50 to 98° C., and preferably the modifying step is carried out for a period in the range of 0.5 hr to 7 hr, and preferably from 0.5 hr to 6 hrs, preferably from 1 hr to 6 hrs.

49. The method according to claim 47, wherein the method includes measuring the viscosity of the composition to determine when to stop the progress of the reaction, and preferably
wherein the method includes a cooling step to stop the progress of the reaction by cooling the composition to a temperature below 50° C., and preferably to a temperature ranging from 15 to 45° C., and preferably
wherein, the cooling step is carried out when the viscosity of the composition reaches a maximum, or has started reducing from a maximum viscosity, to stop the reaction between the modifying agent and the graphene oxide.

50. The method according to claim 49, wherein the modifying step is carried out for at least 1 to 5 hours after a maximum in the viscosity of the composition has occurred before the cooling step, and preferably the modifying step is carried out for at least 2 to 4 hours after a maximum in the viscosity of the composition has occurred before the cooling step.

51. The method according to claim 47, wherein the modifying agent is selected from a group consisting of peracetic acid, benzoyl peroxide, sodium perborate, ammonium hydroxide, alkali hydroxides such as sodium hydroxide and potassium hydroxide, and hydrogen peroxide, and preferably the modifying agent is hydrogen peroxide.

52. The method according to claim 47, wherein the modifying agent is hydrogen peroxide solution which is added to the graphene oxide feed suspension at a mass ratio of modifying agent to the graphene oxide mass in the feed suspension in a range of less than or equal to 15 to 1, preferably 12 to 1, preferably 10 to 1, preferably 9 to 1, preferably 8 to 1, preferably 7 to 1, preferably 6 to 1, preferably 5 to 1, preferably 4 to 1, preferably 3 to 1, preferably 2 to 1, preferably 1 to 1.

53. The method according to claim 47, wherein the method does not include removing, if present, any surplus modifying agent from the composition after the cooling step.

54. The method according to claim 47, wherein the method includes adding a crosslinking additive to the composition, the crosslinking additive being selected from a group consisting of: a molecule or polymer with an epoxide group, an alkoxysilane group, a cationic group provided by quaternary ammonium, or at least two amine groups, and preferably
wherein, the molecule or polymer having the cationic group provided by quaternary ammonium is selected from the group consisting of cationic polyvinyl alcohol, cationic polyacrylamide, cationic poly-urea-ammonium-ether, cationic hydroxyethyl cellulose, cationic guar, and preferably
the molecule or polymer having the epoxide group also has i) an alkoxysilane group including a hydrolysable silanol group, such as 3-glycidyloxypropl trimethoxy silane, which is also known as GLYMO, or ii) a cationic group including trimethylammonium, such as glycidyltrimethylammonium chloride, which is also known as GTAC, and preferably the molecule or polymer having the at least two amine groups is a diamine polymer, such as polyethyleneimine (PEI).

55. A method of making a filter for filtering a fluid, wherein the method includes: applying an adhesive additive to a porous substrate; and
applying the composition to the porous substrate to form a filter having the membrane containing graphene oxide, wherein the composition has been made in accordance with the method of claim 47, and the adhesive additive facilitates bonding of the composition to the substrate.

56. The method according to claim 55, wherein the adhesive additive includes a quaternary ammonium group, and preferably
the adhesive additive is a cationic polymer having quaternary functionality including: cationic polyvinyl alcohol, cationic polyacrylamide, cationic poly-urea-ammonium-ether, cationic hydroxyethyl cellulose, or cationic guar, and preferably
the adhesive additive is a cationic polymer that includes poly diallyldimethylammonium chloride (polyDADMAC), and preferably
the adhesive additive is a cationic polymer that include a modified polyvinylalcohol incorporating at least one quaternary ammonium group, such as GOHSENX™ K.

57. The method according to claim 55, wherein the method includes applying a crosslinking additive to the graphene oxide membrane after the graphene oxide membrane has been applied to the substrate, and preferably after the graphene oxide membrane has dried, and preferably
the adhesive additive includes a dopamine and the method includes initiating polymerisation of the dopamine prior to the adhesive additive being applied to the substrate.

58. The method according to claim 57, wherein the method includes selecting the crosslinking additive from a group comprising: i) a polymer having at least one epoxide group, ii) a molecule having at least one epoxide group, iii) a cationic polymer having at least one quaternary ammonium group, iv) a polymer having at least two amine groups, v) a molecule having at least two amine groups, and preferably
the crosslinking additive includes a cationic polymer having at least one quaternary ammonium group, and preferably
the cationic polymer includes at least one of: cationic polyvinyl alcohol, cationic polyacrylamide, cationic poly-urea-ammonium-ether, cationic hydroxyethyl cellulose, cationic guar, cationic polyDADMAC.

59. The method according to claim 57, wherein the method includes activating the crosslinking additive to complete crosslinking between the graphene oxide sheets, and preferably activating the crosslinking additive includes heating the substrate and the membrane on the substrate above 50° C. for at least 1 hour, and to a temperature of 75° C. for at least 2 hours, and preferably
activating the crosslinking additive includes applying a catalyst, such as aluminium acetylacetonate to the graphene oxide membrane.

60. The filter made by the method according to claim 55, wherein the filter has a rejection ranging from greater than 90.0% to 99.5% under acidic conditions when measured using the Rose Bengal probe molecule in the cross-flow apparatus, and preferably the filter has a permeance ranging from 6.7 to 13.7 (L/m²/h/bar) under acidic conditions when measured using the Rose Bengal probe molecule in the cross-flow apparatus, and preferably, the filter has a rejection ranging from 65.5% to 98.8% under alkaline conditions when measured using the Rose Bengal probe molecule in the cross-flow apparatus, and preferably the filter has a permeance ranging from 10.0 to 25.1 (L/m²/h/bar) under alkaline conditions when measured using the Rose Bengal probe molecule in the cross-flow apparatus.

61. The filter made by the method in accordance with claim 47, wherein the crosslinking additive is one of the following: cationic polyacrylamide (lg/L), cationic poly urea-ammonium-ether (5 g/L), cationic polyacrylamide (lg/L), cationic hydroxyethyl cellulose (lg/L), cationic guar (lg/L), cationic polyDADMAC (5 g/L), and polyamine (5 g/L), and wherein the filter has ranges of rejection values from acid conditions to alkaline conditions measured using the Rose Bengal probe molecule in the cross-flow apparatus as shown in the following table:

| | |
|---|---|
| Crosslinking | Rejection (%) |
| additive | Acidic | Alkaline |
|---|---|---|
| Class | conditions | conditions |
| Cationic | 96.3% | 91.9% |
| polyacrylamide | | |
| Cationic poly urea- | 99.3% | 98.4% |
| ammonium-ether | | |
| Cationic | 98.6% | 95.8% |
| polyacrylamide | | |
| Cationic | 95.8% | 76.7% |
| hydroxyethyl | | |
| cellulose | | |
| Cationic guar | 91.9% | 65.5% |
| Cationic | 99.5% | 98.8% |
| polyDADMAC | | |
| Polyamine | 98.7% | 95.7% |

and preferably the filter has ranges of permeance values from acidic conditions to alkaline conditions measured using the Rose Bengal probe molecule in the cross-flow apparatus as shown in the following table:

| | |
|---|---|
| | Permeance |
| Crosslinking | (L/m²/h/bar) |
| additive | Acidic | Alkaline |
|---|---|---|
| Class | conditions | conditions |
| Cationic | 6.7 | 10.9 |
| polyacrylamide | | |
| Cationic poly urea- | 6.9 | 10.0 |
| ammonium-ether | | |
| Cationic | 9.0 | 12.9 |
| polyacrylamide | | |
| Cationic | 11.0 | 16.3 |
| hydroxyethyl | | |
| cellulose | | |
| Cationic guar | 11.6 | 19.8 |
| Cationic | 13.7 | 25.1 |
| polyDADMAC | | |
| Polyamine | 9.8 | 17.6 |

and preferably the porous substrate is selected from the group comprising a metallic substrate, a ceramic substrate, or a polymeric substrate such as polyvinylidene difluoride.

62. The filter made by the method in accordance with claim 47, wherein the crosslinking additive is a cationic polymer and the adhesive additive is cationic polyvinylalchohol (such as GOHSENX™ K), when exposed to 10,000 ppm.h of chlorine, the filter has a permeance value ranging from 13.7 to 29.8 (L/m²/h/bar) and a rejection value ranging from 90.7% to 98.5% under alkaline conditions, and preferably the filter has a permeance value ranging from 11.0 to 23.8 L/m²/h/bar and a rejection value ranging from 86.6% to 99.5% under acidic conditions, and preferably the porous substrate is selected from the group comprising a metallic substrate, a ceramic substrate, or a polymeric substrate such as polyvinylidene difluoride.

63. The filter made by the method in accordance with claim 55, wherein the crosslinking additive is a diamine polymer with at least two reactive amine groups, and the adhesive additive is cationic polyvinylalchohol (such as GOHSENX™ K), and when exposed to 10,000 ppm.h of chlorine, the filter has a rejection value at least 85%, and suitably a rejection in the range of 85% to 88% and a permeance value ranging from 13 to 15 L/m²/h/bar, and suitably a permeance value of approximately 14.5 L/m²/h/bar under acid conditions, and preferably the porous substrate is selected from the group comprising a metallic substrate, a ceramic substrate, or a polymeric substrate such as polyvinylidene difluoride.

64. A composition containing graphene oxide sheets that can be applied to a porous substrate to make a filter, wherein the graphene oxide sheets have been modified by reacting with a modifying agent to create imperfections in the graphene oxide sheets at an elevated temperature wherein progress of the reaction is stopped by reducing the temperature of the composition to form a stable composition that can be applied to a substrate to form a graphene oxide filtration membrane, and preferably
the modifying agent is selected from a group consisting of peracetic acid, benzoyl peroxide, sodium perborate, ammonium hydroxide, alkali hydroxides such as sodium hydroxide and potassium hydroxide, and hydrogen peroxide, and preferably the modifying agent is hydrogen peroxide, and preferably
the modifying agent is hydrogen peroxide and was added to the graphene oxide feed suspension at a mass ratio of modifying agent to the graphene oxide mass in the feed suspension in a range of less than or equal to 15 to 1, preferably 12 to 1, preferably 10 to 1, preferably 9 to 1, preferably 8 to 1, preferably 7 to 1, preferably 6 to 1, preferably 5 to 1, preferably 4 to 1, preferably 3 to 1, preferably 2 to 1, preferably 1 to 1.

65. The composition according to claim 64, wherein the composition is stable without removing the modifying agent from the composition.

66. The composition according to claim 64, wherein the composition includes a crosslinking additive in which the crosslinking additive is selected from a group consisting of: a molecule or polymer with an epoxide group, an alkoxysilane group, a cationic group provided by quaternary ammonium, or at least two amine groups, and preferably
the molecule or polymer having the cationic group is provided by quaternary ammonium is selected from the group consisting of cationic polyvinyl alcohol, cationic polyacrylamide, cationic poly-urea-ammonium-ether, cationic hydroxyethyl cellulose, cationic guar, and preferably
the molecule or polymer having the epoxide group also has i) an alkoxysilane group including a hydrolysable silanol group, such as 3-glycidyloxypropl trimethoxy silane, which is also known as GLYMO, or ii) a cationic group such as glycidyltrimethylammonium chloride, which is also known as GTAC, and preferably
the molecule or polymer having the at least two amine groups is a diamine polymer, such as polyethyleneimine (PEI).
